(19) United States
(12) Patent Application Publication
(10) Pub. No.: US 2006/0136823 A1
(43) Pub. Date: Jun. 22, 2006

(54) Image processing device

(75) Inventor: Kenji Dokuni, Kyoto-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 11/270,239

(22) Filed: Nov. 8, 2005

(30) Foreign Application Priority Data
Dec. 22, 2004 (JP) 2004-370631

(51) Int. Cl. G06F 15/00; G06F 17/24

(52) U.S. Cl. 715/530

(57) ABSTRACT

An image processing device includes a file memory, an editing unit and an operation unit. The editing unit includes a page number editing unit and an assigning unit. The file memory stores image information of a plurality of pages and page number information of each of the pages as a multipage file. The editing unit edits a file structure so as to add additional image information as a new page to the multipage file. When adding the additional image information to the multipage file, the operation unit accepts an entry of an insertion position of the additional image information. The page number editing unit reassigns consecutive edited page numbers to the image information of all of the pages including the additional image information. The assigning unit assigns an additional page number to the additional image information according to the insertion position of the additional image information.

### BACKGROUND OF THE INVENTION

1. Field of the Invention

The present invention relates to an image processing device having a storage unit which stores image information of a plurality of pages and page information associated with the image information of each of the pages as a multipage file.

2. Description of the Related Art

A known facsimile machine inserts an additional page between any pages of a file of stored transmission data. Before fixing and editing, the facsimile machine can cancel the insertion of the additional page.

The facsimile machine can insert a plurality of additional pages between any pages of a file. However, when an editing is fixed once, an identifier assigned to each of the additional pages is changed and page numbers of all of the pages are updated. Therefore, after the editing is fixed, the additional pages cannot be specified.

### SUMMARY OF THE INVENTION

The present invention has been made in order to overcome the problems described above. An advantage of the present invention is to provide an image processing device which inserts additional image information between any pages of a file stored as a multipage file and carries out an image processing to enable the additional image information to be specified even after an editing is made.

According to an aspect of the present invention, an image processing device includes a storage unit, an editing unit, and an insertion position accepting unit. The editing unit includes a page number editing unit and an additional page number assigning unit. The storage unit stores image information of a plurality of pages along with page number information of each of the pages in a form of a multipage file. The editing unit edits a file structure so as to add additional image information as a new page to the multipage file. The insertion position accepting unit accepts an entry of an insertion position of the additional image information when adding the additional image information to the multipage file. The page number editing unit reassigns consecutive edited page numbers to the image information of all of the pages including the additional image information. The additional page number assigning unit assigns an additional page number to the additional image information according to the insertion position of the additional image information.

According to an aspect of the present invention, the additional page number includes a page number of the image information located immediately before the insertion position of the additional image information. The additional page number may be provided in a hierarchical structure which a hierarchy changes accompanying an update of the file structure carried out by the editing unit.

According to an aspect of the present invention, the image processing device also includes an operator identification information accepting unit which accepts an entry of operator identification information for specifying a person who performs a file editing operation. The editing unit can store the operator identification information as page information corresponding to additional image information.

According to an aspect of the present invention, the image processing unit also includes an operator identification information accepting unit which accepts an entry of operator identification information for specifying a person who performs a file editing operation. The editing unit can switch whether or not to assign an additional page number by the additional page number assigning unit according to the operator identification information accepted by the operator information accepting unit.

According to the above-described aspects of the present invention, when inserting the additional image information to the multipage file stored in the storage unit, the editing unit edits the file structure so that the additional image information is added to the insertion position accepted by the insertion position accepting unit. In addition, the additional page number assigned by the additional page number assigning unit is associated with the additional image information. Meanwhile, the page number editing unit assigns again consecutive edited page numbers to the image information of all of the pages including the additional image information after the editing is made. Accordingly, the file stored in the storage unit includes both the additional page number and the edited page numbers.

According to the above-described aspects of the present invention, when additional image information is inserted between any pages of a file stored as a multipage file, the additional image information can be specified even after an editing is made.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating a control configuration of a Multi-Function Peripheral (MFP) according to a preferred embodiment of the present invention.

FIG. 2 illustrates a multipage file.

FIG. 3 illustrates an operation panel displaying a menu list.

FIG. 4 illustrates an operation panel displaying page information stored in a file memory.

FIG. 5 illustrates an operation panel displaying page information of a multipage file.

FIG. 6 illustrates an example of an operation panel displaying page information after an editing process.

FIG. 7 illustrates an example of a multipage file after an editing operation.

FIG. 8 illustrates another example of an operation panel displaying page information after an editing process.

FIG. 9 illustrates another example of an operation panel displaying page information after an editing process.

FIG. 10 illustrates another example of a multipage file after an editing operation.

FIG. 11 illustrates an example of an operation panel displaying an entry screen of a user name and a password.

### DETAILED DESCRIPTION OF PREFERRED EMBODIMENTS

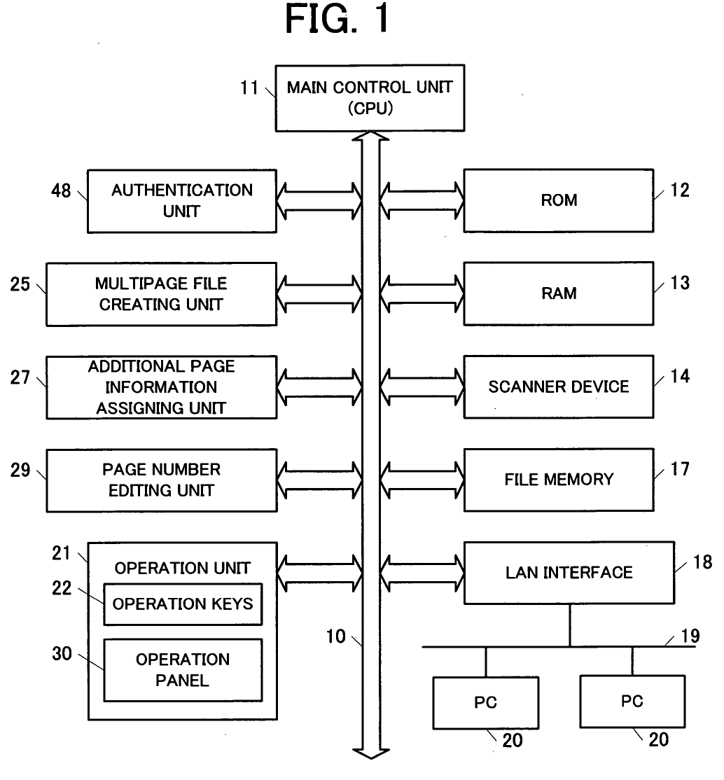

With reference to the drawings, a description will be made of a digital MFP having a part or all of a copy function, a fax function, a printer function and a scanner function, as an image processing device according to a preferred embodiment of the present invention. FIG. 1 is a block diagram illustrating an overview of the digital MFP according to a preferred embodiment of the present invention.

A Central Processing Unit (CPU) 11 is a control unit which controls each component of the digital MFP in accordance with a control program stored in a Read Only Memory (ROM) 12, in accordance with an input operation or the like performed from an operation unit 21. A Random Access Memory (RAM) 13 temporarily stores various pieces of information, such as a control status of the digital MFP. The RAM 13 provides a working area of the CPU 11.

The operation unit 21 includes various operation keys 22 for operating the digital MFP. An input operation performed from each of the operation keys 22 is transmitted to the CPU 11. In accordance with the input operation, the CPU 11 controls the digital MFP.

The operation unit 21 includes an operation panel 30, which also functions as a display unit. The operation panel 30 includes a display having a touch screen function. For example, the operation panel 30 displays various pieces of information (a character message) relating to an operational state of the digital MFP and an editing status of a multipage file, and an operational procedure of the digital MFP. The operation panel 30 also displays various operation keys 22 for operating the digital MFP according to the operational state of the digital MFP. In these cases, the CPU 11 retrieves panel image data stored in the ROM 12 to be displayed on the operation panel 30. Then, the retrieved panel image data is displayed on the operation panel 30. When an input operation is performed from each operation key 22 displayed on the operation panel 30, the input operation is transmitted to the CPU 11 and the CPU 11 controls the digital MFP in accordance with the input operation.

The operation unit 21 also functions as an insertion position accepting unit and an operator identification information accepting unit described hereinafter.

A scanner device 14 includes an automatic document transportation device which enables a plurality of original documents to be scanned continuously when necessary. The scanner device 14 optically scans an original document of a photograph, a document, a drawing, or the like. The scanner device 14 measures strength of a reflected light and a transmitted light and carries out an analog-to-digital (AD) conversion. Then, the scanner device 14 outputs image information, which is image data. The image information of the original document scanned by the scanner device 14 is stored into a file memory 17, which is a storage unit. Further, the scanner device 14 can use a monochrome scanner having a monochrome scanning function and can also use a color scanner having a monochrome scanning function and a color scanning function.

A multipage file creating unit 25 is specifically formed of a creation program or a creation circuit. When the multipage file creating unit 25 is formed of a creation program, the creation program is stored in the ROM 12. The CPU 11 appropriately retrieves the creation program from the ROM 12 and expands the retrieved creation program in the RAM 13. Then, the CPU 11 executes a file creation process. The multipage file creating unit 25 creates a multipage file of image information of a plurality of pages scanned by the scanner device 14 and stores the created multipage file into the file memory 17. The image information is a Tagged Image File Format (TIFF) file or a Portable Document Format (PDF) file, for example. Further, even when the image information scanned by the scanner device 14 includes only one page, by adding image information, a file results in having a plurality of pages. Therefore, the image information including only one page is also handled as a multipage file.

The file memory 17 is a storage unit which stores image information of a plurality of pages and page information associated with the image information of each of the pages as a multipage file.

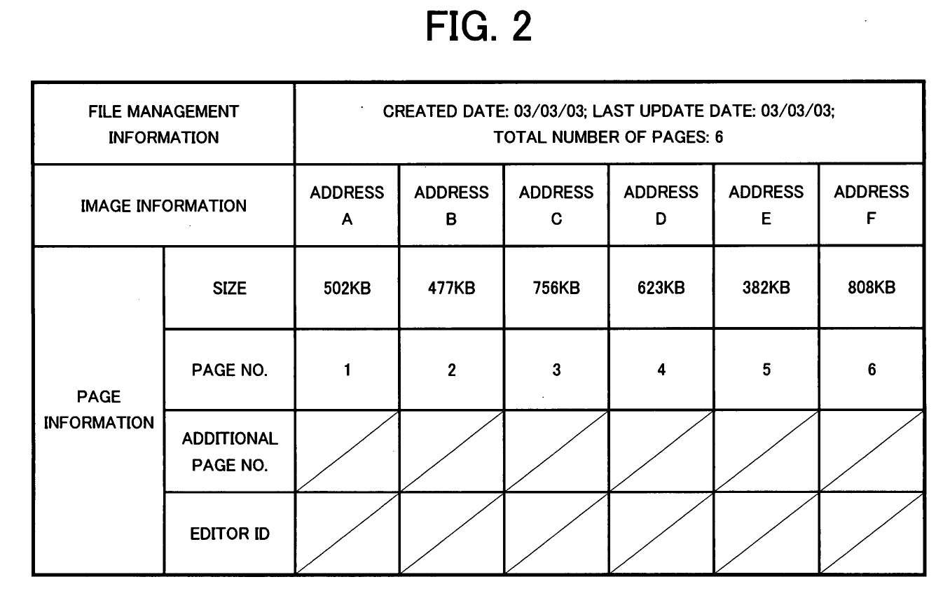

FIG. 2 illustrates an example of a multipage file. A multipage file generally includes image information of a plurality of pages (in FIG. 2, six pages). The multipage file includes top addresses, page information, and file management information. The top addresses are an address A through an address F, for example, where image data of a corresponding page is actually stored. The page information is associated with each image information. The file management information includes information such as a created date, a last update date and a total number of pages. In the present embodiment, the page information includes a page number (such as an original page number, an edited page number after an editing process is carried out or an additional page number described hereinafter), a size of the image information, and an editor ID.

For example, in case of a TIFF file, the page information can be written into a custom tag provided as an area for a user to write in any necessary information. The custom tag is recognized by compatible application software capable of reading the custom tag, but is not recognized by non-compatible application software. Therefore, when the custom tag cannot be recognized, the custom tag is skipped. Accordingly, even in case of an environment where application software incapable of retrieving the custom tag is operating, the multipage file can be retrieved as a general file storing the image information.

An edited file, such as a file to which image information has been added, has both the edited page numbers and the additional page number as information relating to the page number. Further, the additional page number is assigned after an image is added. When processing the edited file by compatible application software (for example, an image viewer), for example, when displaying the edited file, the edited file can be processed by software that can recognize the additional page number and also by software that cannot recognize the additional page number. Further, the software that can recognize the additional page number can recognize whether or not the edited file includes additional image information and/or which image information is the additional image information.

In case of the software that can recognize the additional page number, when pages to be displayed are fed sequentially, the additional page number is displayed as the page number for a page (image information) having the additional page number. Accordingly, the user can recognize that the page is additional image information just by looking at the page number of such a page. Furthermore, as to be described later, when the additional page number is provided in a form of a hierarchical structure according to a number of times the file has been updated, although the user may not be able to confirm a date and time of the update of each page, the user can recognize an updated period just by looking at the additional page number. That is, the user can recognize in which hierarchical order the update of the page has been carried out.

Meanwhile, in case of the software that cannot recognize the additional page number, when pages to be displayed are fed sequentially, the consecutive edited page numbers are sequentially retrieved and displayed. In this case, since the software cannot recognize the additional page number, the additional page number is not displayed. Therefore, in this case, the user cannot recognize which page is the additional image information.

Referring to FIG. 1 again, the operation unit 21 accepts the operation of the digital MFP as described above. The operation unit 21 also functions as an insertion position accepting unit. The operation unit 21 accepts an operation for designating a multipage file to be added with new image information from multipage files stored in the file memory 17. When there exists image information to be added to the prescribed file, the operation unit 21 accepts an entry of information relating to an insertion position of the additional image information (such as information indicating a position between pages where the additional image information is to be inserted). Further, the insertion position may be located at a top of the multipage file or at an end of the multipage file. Alternatively, the insertion position may be located between any pages. That is, the additional image information is not pasted in a certain image. The additional image information is added as a new page.

An additional page information assigning unit 27 functions as an additional page number assigning unit. Specifically, the additional page information assigning unit 27 is formed of an assigning program or an assigning circuit. When the additional page information assigning unit 27 is formed of an assigning program, the assigning program is stored in the ROM 12. The CPU 11 appropriately retrieves the assigning program from the ROM 12 and expands the retrieved assigning program in the RAM 13. Then, the CPU 11 executes an additional page number assigning process. The additional page information assigning unit 27 assigns an additional page number to the additional image information according to the insertion position accepted by the operation unit 21. That is, the additional page information assigning unit 27 determines a content of an additional page number to be assigned to the additional image information according to the insertion position of the additional image information. As to be described later, the additional page information assigning unit 27 also assigns information to be added to the page information of the additional image information according to necessity. For example, the additional page information assigning unit 27 assigns information such as an editor ID and an update date.

A page number editing unit 29 is specifically formed of an editing program or an editing circuit. When the page number editing unit 29 is formed of an editing program, the editing program is stored in the ROM 12. The CPU 11 appropriately retrieves the editing program from the ROM 12 and expands the retrieved editing program in the RAM 13. Then, the CPU 11 executes a page number editing process. The page number editing unit 29 functions as an editing unit which associates the additional image information with the additional page number assigned by the additional page information assigning unit 27, and inserts the additional image information into a position corresponding to the additional page number. That is, when one or a plurality of additional image information is added to a multipage file and the multipage file is edited, the page number editing unit 29 stores the additional page number assigned by the additional page information assigning unit 27 and the additional image information as data constituting the multipage file. Further, as described above, a multipage file before being edited is not limited to a multipage file having a plurality of pages. The multipage file before being edited may include one or a plurality of image information.

The page number editing unit 29 also functions as a page number editing unit which reassigns consecutive numbers to page numbers of each image information of the edited file. That is, the page numbers are reassigned according to an order of the image information included in the multipage file added with the additional image information. The multipage file can include the reassigned page numbers as the edited page numbers. In the example illustrated in FIG. 2, the page numbers are indicated by 1, 2 and so forth. However, the page numbers can be indicated by another method capable of identifying an order. For example, the page numbers can be indicated by A, B and so forth.

The multipage file updated by the page number editing unit 29 is transmitted and stored into the file memory 17 in accordance with the control of the CPU 11.

The digital MFP can be connected to a remote terminal device 20, such as a Personal Computer (PC), via a Local Area Network (LAN) 19 by a LAN interface 18.

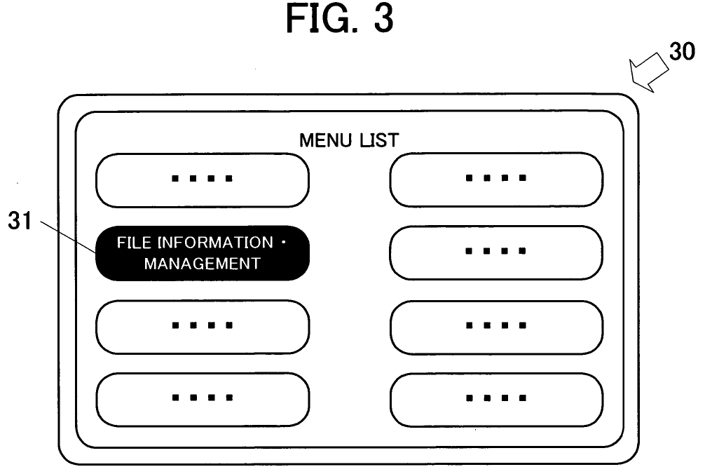

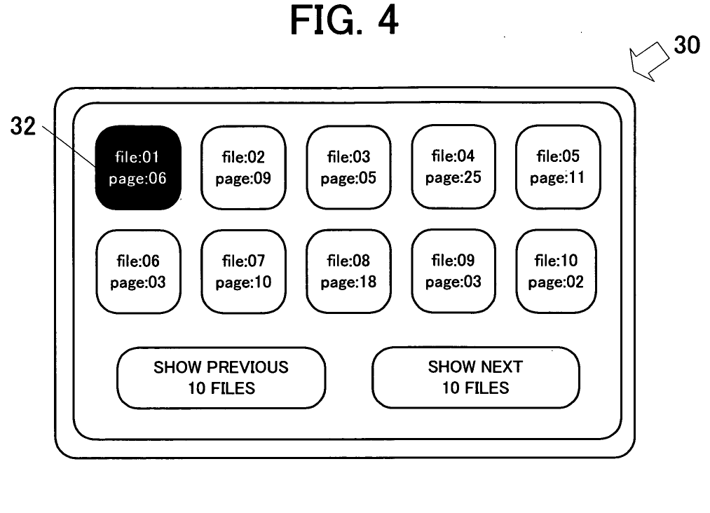

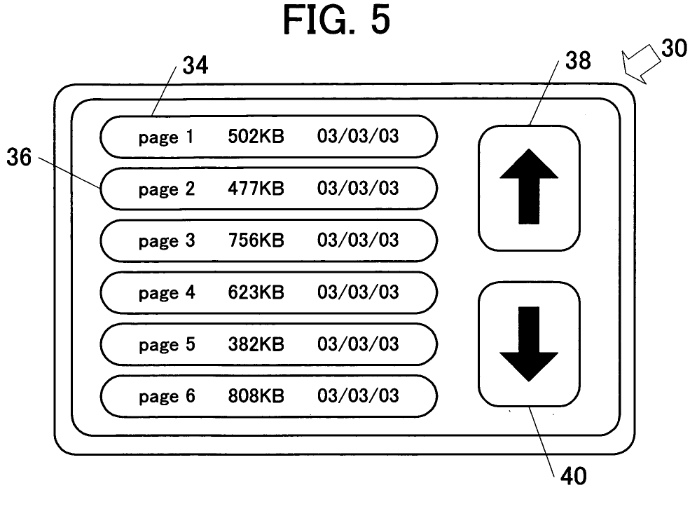

When carrying out a management of the file information, a display of the operation panel 30 as the display unit switches from a menu list illustrated in FIG. 3 to a file selection screen illustrated in FIG. 4. The display of the operation panel 30 switches further to a file editing screen illustrated in FIG. 5.

FIG. 3 illustrates a display screen of the operation panel 30 displaying a menu list of the digital MFP. FIG. 3 illustrates a state in which a button 31 displayed as “FILE INFORMATION MANAGEMENT” has been operated. By performing this operation, the display of the operation panel 30 switches to a display of the file selection screen illustrated in FIG. 4. Accordingly, a multipage file stored in the file memory 17 as described above can be referenced.

FIG. 4 illustrates a state in which a file name (for example “file:01”) of a multipage file stored in the file memory 17 and a number of pages of image information stored in each file are displayed within one button. A list of file names of multipage files is displayed. By selecting a specific file name from the list, a multipage file to be edited (to be executed with an editing process for adding a page) can be selected. FIG. 4 illustrates an example in which a button 32 displaying “file:01” and “page:C6” has been operated. By performing this operation, the display of the operation panel 30 switches to a display of the file editing screen illustrated in FIG. 5. Accordingly, a content of the designated multipage file, in other words, page information of the designated multipage file, can be referenced.

FIG. 5 illustrates a state in which contents of one designated multipage file are displayed within one button. The contents of the multipage file include a page number corresponding to the image information of each page, a size of the image information, and a date when the image information has been added (in this case, the date is the same as the date when the file has been created). The operation panel 30 also displays scroll buttons 38 and 40 for displaying page information that is beyond the display of the operation panel 30 and not displayed on the display of the operation panel 30.

Next, a description will be made of an operation for inserting image information into a multipage file and an editing process carried out when this operation is performed.

For example, in a reference screen illustrated in FIG. 5, when inserting image information after page 1, the user operates either one of buttons corresponding to pages at front and back of a part where the image information is to be inserted. That is, the user operates either a button 34 of page 1 or a button 36 of page 2. Then, according to necessity, the display of the operation panel 30 switches to a screen (not illustrated) for accepting a designation of an insertion position of the image information, in other words, a designation of whether to add the image information to front or back of the button that has been operated. Then, the display of the operation panel 30 switches to a screen (not illustrated) for specifying additional image information.

The operation panel 30 also displays a button corresponding to image information as a candidate of each additional image information. A reduced image may be displayed on the button. Alternatively, a file name may be defined and the file name may be displayed on the button. Moreover, according to necessity, a size and a created date of each image information may be displayed within a button or in proximity of the button.

One or a plurality of additional image information can be added to one multipage file. A plurality of image information can be inserted to one insertion position, such as, for example between an N-th page and an (N+1)-th page. In this case, the entire multipage file having the plurality of the image information can be designated as the additional image information.

The candidate of the image information can be previously scanned into the scanner device 4. Alternatively, after starting an operation relating to an addition of an image, the candidate of the image information can be scanned into the scanner device 14. Instead of scanning an original document by the scanner device 14, an original document can be transmitted from the remote terminal device 20 via the LAN 19 to the digital MFP.

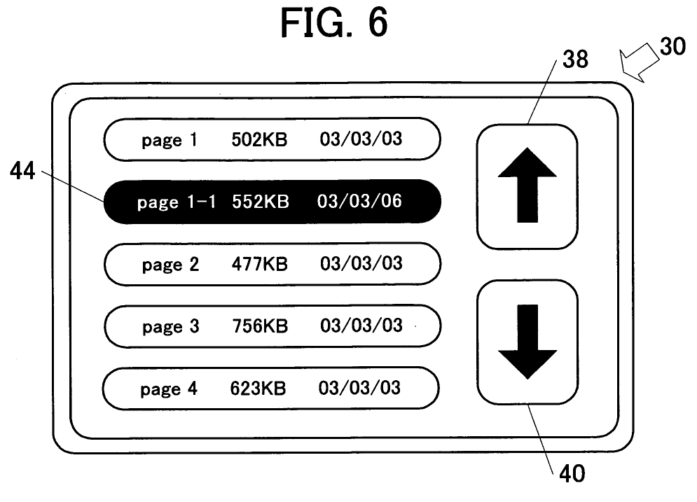

When an operation is performed on a button corresponding to one image information among candidates of the additional image information displayed on the operation panel 30, the page number editing unit 29 of FIG. 1 executes an editing process. Then, the display of the operation panel 30 switches to a display of the file editing screen illustrated in FIG. 6.

FIG. 6 illustrates a display screen displaying a state in which an additional page 1-1 has been inserted between page 1 and page 2. A button 44 of the additional page 1-1 displays that an additional page number of the additional image information is page 1-1, a size of the image information is 552 KB, and a date when the additional image information has been added is “Mar. 3, 2006”. A created date of the additional image information can be included in the additional page information along with the date when the additional image information has been added, and the created date can also be displayed.

As described above, the additional page number of the additional image information assigned by the additional page information assigning unit 27 is sequence information having a different order from the consecutive page numbers of the multipage file. The additional page number is indicated as “1-1” including a page number of the page located immediately before the insertion position. In this case, the additional page number can be page information including a page number of a page located immediately after the insertion position.

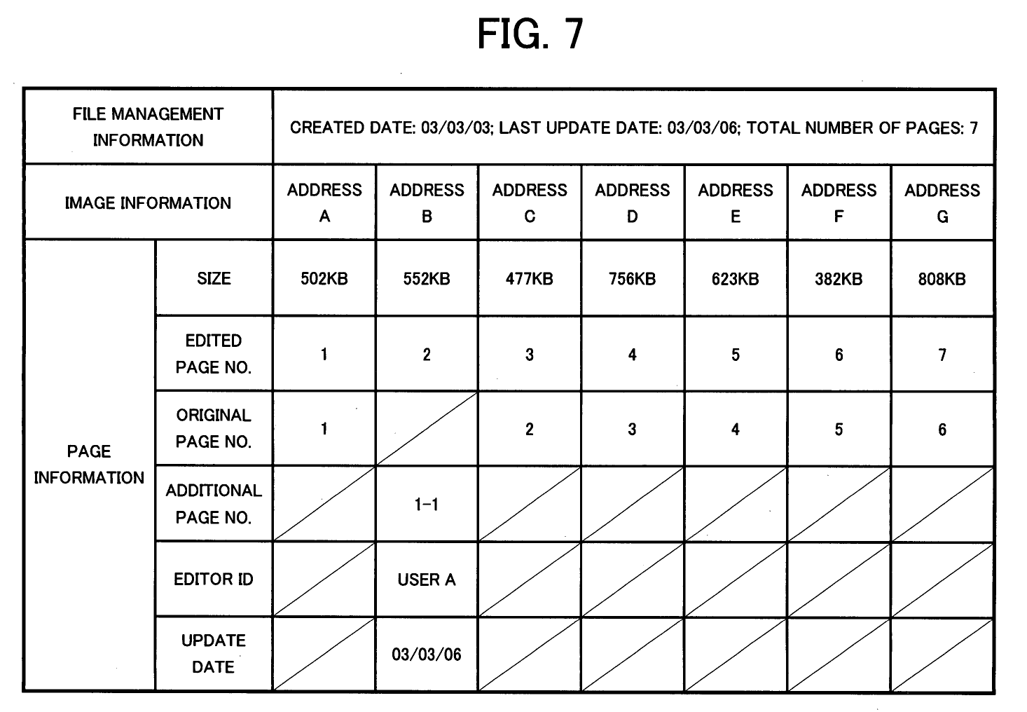

FIG. 7 illustrates a data structure of a multipage file. That is, the multipage file includes file management information, image information and page information. The page information includes an initial original page number before an editing is made. The page information also includes an additional page number, an editor ID and an update date with respect to the additional image information. In the example illustrated in FIG. 7, the file management information includes “Mar. 3, 2003” as a created date, “Mar. 3, 2006” as a last update date and “7” as a total number of pages. An edited page number includes consecutive numbers 1 through 7 which have been renumbered from a top of the image information after an editing process has been carried out. The page information includes an edited page number of each image information, an original page number, an additional page number, a size of image information, an editor ID “USER A” who added and edited the additional image information according to necessity, and an update date.

Further, the editor ID may be an ID entered by requesting the user to enter when the editing process is carried out. Alternatively, when carrying out an authentication described hereinafter, the editor ID may be an ID entered at the authentication.

In the example illustrated in FIG. 7, image information specified by a page number “2” as an edited page number is additional image information. The date when the image information has been added is “Mar. 3, 2006”, and the user A has performed the editing process for adding the image information. Moreover, in the file editing screen illustrated in FIG. 6, an edited page number and according to necessity, an editor ID of the user who has performed the editing process for adding the additional image information can also be displayed in each button.

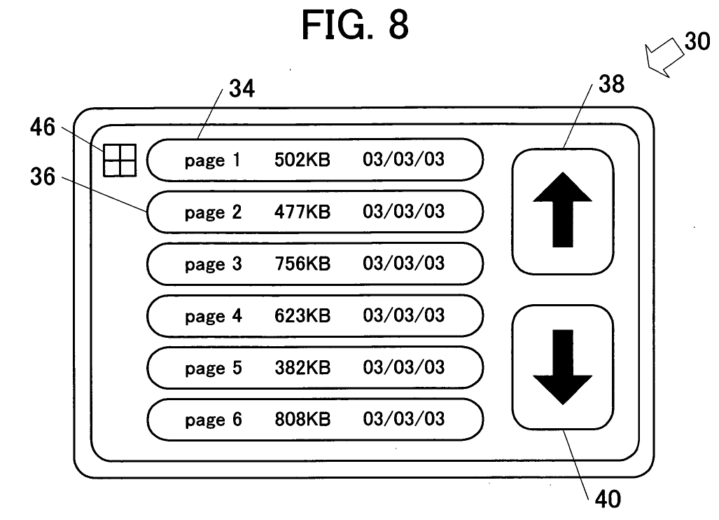

As illustrated in FIG. 8, an addition button 46 indicating that additional image information has been inserted can be displayed near a button to which an editing operation has been performed, for example, the button 34. When the addition button 46 is operated, the display of the operation panel 30 can be switched to the display of the file editing screen illustrated in FIG. 6.

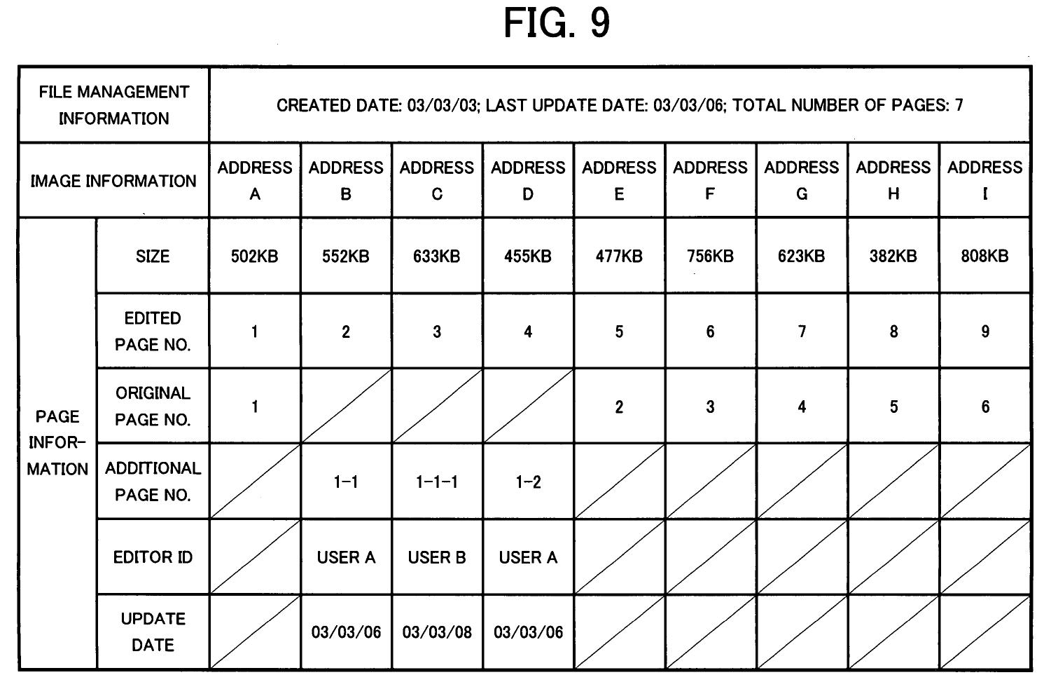

FIG. 9 illustrates an example of a multipage file when image information is added again to the multipage file to which the image information has been already added. In the example illustrated in FIG. 9, in a first editing process (carried out on “Mar. 3, 2006”), two images of page 1-1 and page 1-2 are inserted between page 1 and page 2. In a subsequent editing process (carried out on “Mar. 3, 2008”), an image of page 1-1-1 is inserted between page 1-1 and page 1-2. As described above, the page number of the additional image information includes a page number of a page located immediately before an insertion position of the additional image information. Furthermore, a hyphen (“-”) and a “subnumber” are attached to the page number of the additional image information. Further, a page number before the first editing process is stored as the original page number.

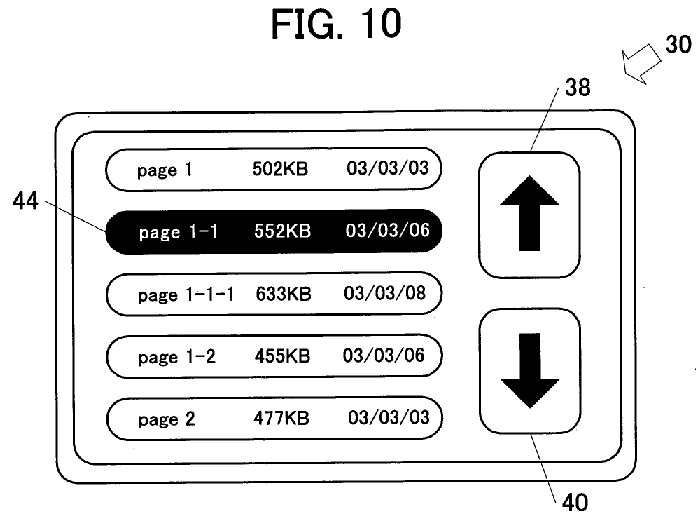

FIG. 10 illustrates an example of a display of the multipage file illustrated in FIG. 9. FIG. 10 illustrates a display screen displaying a state in which additional page 1-1-1 has been inserted between additional page 1-1 and additional page 1-2, which have been already inserted between page 1 and page 2. Although not illustrated in the drawings, a presence or an absence of additional image information can be expressed by using the addition button 46 of FIG. 8. Accordingly, the additional image information can be managed hierarchically.

In addition to a hyphen (“-”) by using an underscore (“_”), a slash (“/”), an asterisk (“*”), a sharp (“#”) or the like where a hierarchy of an additional page number changes, such as, for example, where a period of the editing process changes, hierarchical information can be added to the additional page number. Further, the hierarchical information indicates in which editing process the image information has been added.

For managing the additional image information hierarchically, instead of using a symbol to be a separator as given above, a depth of the hierarchy can be indicated by a number of digits of a page number. For example, an insertion of additional image information in a first hierarchy (a first editing process) can be expressed by one digit. An insertion of additional image information in a second hierarchy (a second editing process) can be expressed by two digits. An insertion of additional image information in a third hierarchy (a third editing process) can be expressed by three digits. That is, an insertion of additional image information in an N-th hierarchy can be expressed by N digits. In this case, it is necessary to store in which hierarchy the previous additional image information has been inserted. For example, a value indicating the hierarchy can be included in a header of the multipage file. Accordingly, when inserting one additional image information between page 1 (existing prior to the editing process) and page 1-1 (inserted in the first editing process) in the second editing process, the additional page number of the additional image information to be inserted can be expressed by

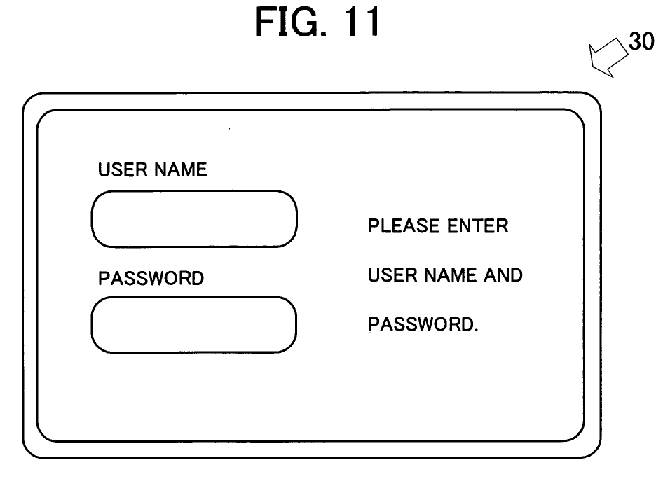

When editing page information, a user authentication screen illustrated in FIG. 11 can be displayed according to necessity. In this case, the operation unit 21 functions as an operator identification information accepting unit, which accepts an entry of a user name and a password for specifying a user, who is an operator. This operation includes a multipage file creating operation and an editing operation.

Referring to FIG. 1 again, an authentication unit 48 is specifically formed of an authentication program or an authentication circuit. When the authentication unit 48 is formed of an authentication program, the authentication program is stored in the ROM 12. The CPU 11 appropriately retrieves the authentication program from the ROM 12 and expands the retrieved authentication program in the RAM 13. Then, the CPU 11 executes an authentication process. The authentication unit 48 executes a process for authenticating a user name accepted by the operation unit 21. Specifically, the authentication unit 48 compares the entered user name and the entered password with previously registered authentication data and authenticates the operator.

The additional page information assigning unit 27 assigns the operator identification information, and includes the user name as the operator identification information into the page information of the additional image information. Then, the operator identification information corresponding to the additional image information is displayed. Accordingly, a user can recognize an operator (editor) who has performed an editing operation for adding the additional image information.

In accordance with the operator identification information, a determination is carried out as to whether the operator is a manager having a certain authority over an editing of a file or whether the operator is a general operator not having such an authority. This determination can be carried out by a password authentication, for example. That is, when a password for a manager is entered, a determination can be made that an editing is carried out by a manager. When a password for a manager is not entered, or when a password for a general operator is entered, a determination can be made that an editing is carried out by a general operator.

When a determination is made that the editing is carried out by the manager, an additional page number is not assigned and just the edited page numbers are reassigned. In addition, the editor ID is not stored. Accordingly, even when the manager rewrites an original file, a third party cannot recognize that the file has been edited even by looking at the page numbers.

Meanwhile, when a determination is made that the editing is carried out by the general operator, an additional page number is added, and the edited page numbers are reassigned. In addition, the editor ID is stored. Accordingly, the original file can be prevented from being rewritten by the general operator other than the manager.

When rewriting the original file, the date when the additional image information has been added, in other words, the update date, is not stored as the page information. When rewriting a file that is not the original file, with respect to the additional image information, the update date is stored as the page information. Accordingly, when a file that is not the original file is rewritten, information relating to when the additional image information has been added can be grasped easily by displaying the page information on the operation panel.

The above-described editing operation or the entry operation of the operator identification information for authentication may be carried out from the remote terminal device 20 instead of from the operation panel 30. A host name or the like may be assigned to the remote terminal device 20, and the host name and a login state may be processed as an entry of the operator identification information. Accordingly, the entry operation of the operator identification information can be omitted.

As described above, according to the preferred embodiment of the present invention, an image processing can be carried out in a manner that, when additional image information is inserted between any pages of a file stored as a multipage file, the additional image information can be specified even after the file is edited.

By having the entry operation of the operator identification information carried out by the user, an authority relating to the editing of a file can be assigned. For example, an editing made by the manager can be handled as an original rewriting in which an edited part cannot be recognized by a third party, and an editing made by a general operator can be handled as a rewriting in which an edited part can be recognized easily.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the invention.

What is claimed is:

1. An image processing device, comprising:
means for storing image information of a plurality of pages along with page number information of each of the pages as a multipage file;
means for editing a file structure so as to add additional image information as a new page to the multipage file; and
means for accepting an entry of an insertion position of the additional image information when adding the additional image information to the multipage file,
wherein the means for editing includes:
means for reassigning consecutive edited page numbers to the image information of all of the pages including the additional image information; and
means for assigning an additional page number of a content according to the insertion position of the additional image information to the additional image information.

2. The image processing device according to claim 1, wherein the additional page number includes a page number of image information located immediately before the insertion position of the additional image information.

3. The image processing device according to claim 1, wherein the additional page number has a hierarchical structure which a hierarchy changes accompanying an update of a file structure carried out by the means for editing.

4. The image processing device according to claim 2, wherein the additional page number has a hierarchical structure which a hierarchy changes accompanying an update of a file structure carried out by the means for editing.

5. The image processing device according to claim 1, further comprising means for accepting an entry of operator identification information to specify a person who carries out a file editing operation,
wherein the means for editing stores the operator identification information as page information corresponding to the additional image information.

6. The image processing device according to claim 2, further comprising means for accepting an entry of operator identification information to specify a person who carries out a file editing operation,
wherein the means for editing stores the operator identification information as page information corresponding to the additional image information.

7. The image processing device according to claim 3, further comprising means for accepting an entry of operator identification information to specify a person who carries out a file editing operation,
wherein the means for editing stores the operator identification information as page information corresponding to the additional image information.

8. The image processing device according to claim 4, further comprising means for accepting an entry of operator identification information to specify a person who carries out a file editing operation,
wherein the means for editing stores the operator identification information as page information corresponding to the additional image information.

9. The image processing device according to claim 1, further comprising means for accepting an entry of operator identification information to specify a person who carries out a file editing operation,
wherein the means for editing switches whether or not to assign an additional page number by the means for assigning according to the operator identification information accepted by the means for accepting the entry of the operator identification information.

10. The image processing device according to claim 2, further comprising means for accepting an entry of operator identification information to specify a person who carries out a file editing operation,
wherein the means for editing switches whether or not to assign an additional page number by the means for assigning according to the operator identification information accepted by the means for accepting the entry of the operator identification information.

11. The image processing device according to claim 3, further comprising means for accepting an entry of operator identification information to specify a person who carries out a file editing operation,
wherein the means for editing switches whether or not to assign an additional page number by the means for assigning according to the operator identification information accepted by the means for accepting the entry of the operator identification information.

12. The image processing device according to claim 4, further comprising means for accepting an entry of operator identification information to specify a person who carries out a file editing operation,
wherein the means for editing switches whether or not to assign an additional page number by the means for assigning according to the operator identification information accepted by the means for accepting the entry of the operator identification information.
